(19) United States
(12) Patent Application Publication
(10) Pub. No.: US 2006/0061066 A1
(43) Pub. Date: Mar. 23, 2006

(54) Foldable stroller

(76) Inventor: Yi-Cheng Tan, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/944,728

(22) Filed: Sep. 21, 2004

(51) Int. Cl. B62B 7/00

(52) U.S. Cl. 280/642

(57) ABSTRACT

A foldable stroller includes a main frame, a seat frame, two pivotal mechanisms, and a handle. The main frame includes a front wheel frame and a rear wheel frame that are pivotally connected to the pivotal mechanisms. The seat frame includes an annular frame and two connecting beams. Each end of the handle is pivotally connected to an associated pivotal mechanism. Each connecting beam includes an end pivotally connected to an associated pivotal mechanism. The annular frame includes two coupling sections on two opposite lateral portions thereof. Each coupling section is pivotally connected to the end of an associated connecting beam.

### BACKGROUND OF THE INVENTION

1. Field of the Invention

The present invention relates to a stroller. In particular, present invention relates to a foldable stroller.

2. Description of the Related Art

A typical stroller comprises a main frame including a front wheel frame, a rear wheel frame, a seat frame, and a handle. To allow folding of the stroller, the main frame has a complicated structure and thus requires troublesome folding operation. Further, the user's fingers are apt to be pinched by the foldable members. Further, the foldable strollers with a complicated structure damage easily and thus require frequent maintenance. Further, the linking members for interconnecting the parts of the main frame are weak, as they relatively thin for allowing overlapping and for not interfering with the folding operation. Further, folding of the seat frame in a horizontal plane is not convenient. As a result, separate detachment is required.

### SUMMARY OF THE INVENTION

In accordance with an aspect of the present invention, a foldable stroller comprises a main frame, a seat frame, two pivotal mechanisms, and a handle. The main frame includes a front wheel frame having two arms and a rear wheel frame having two arms. The seat frame includes an annular frame and two connecting beams.

Each arm of the front wheel frame is pivotally connected to an associated one mechanism. Each arm of the rear wheel frame is pivotally connected to an associated pivotal mechanism. Each end of the handle is pivotally connected to an associated pivotal mechanism. Each connecting beam includes an end pivotally connected to an associated pivotal mechanism.

The annular frame includes two coupling sections on two opposite lateral portions thereof. Each coupling section is pivotally connected to the end of an associated connecting beam.

In an embodiment, each coupling section includes an engaging member mounted therein. The other end of the associated connecting beam includes a plurality of annularly spaced engaging teeth. The engaging member is releasably engaged with the engaging teeth. Relative pivotal movement between each coupling section and the associated connecting beam is not allowed when the engaging member is engaged with the engaging teeth. Relative pivotal movement between each coupling section and the associated connecting beam is allowed when the engaging member is disengaged from the engaging teeth.

The annular frame includes two compartments respectively adjacent to the coupling sections. An actuating member is movably mounted in each compartment. An elastic element is attached between each actuating member and an associated engaging member. The engaging member is disengaged from the engaging teeth when the actuating member is moved from a locking position to an unlocking position.

The foldable stroller in accordance with the present invention allows rapid folding through simple operation. The structure of the foldable stroller is simple and strong and thus easy to maintain.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a foldable stroller in accordance with the present invention.

FIG. 2 is an exploded perspective view showing a first pivotal mechanism of the foldable stroller in accordance with the present invention.

FIG. 3 is a perspective view of the first pivotal mechanism of the foldable stroller in an unfolded state.

FIG. 4 is an exploded perspective view showing a second pivotal mechanism of the foldable stroller in accordance with the present invention.

FIG. 5 is a perspective view showing the second pivotal mechanism of the foldable stroller in accordance with the present invention.

FIG. 6 is an elevational view of the second pivotal mechanism of the foldable stroller in accordance with the present invention.

FIG. 7 is a view similar to FIG. 6, wherein an actuating member is pulled.

FIG. 8 is a view similar to FIG. 6, illustrating pivotal movement of the second pivotal mechanism.

FIG. 9 is a side view illustrating a first folding step of the foldable stroller in accordance with the present invention.

FIG. 10 is a side view illustrating a second folding step of the foldable stroller in accordance with the present invention.

FIG. 11 is a side view of the foldable stroller after the second folding step.

FIG. 12 is a side view illustrating a third folding step of the foldable stroller in accordance with the present invention.

FIG. 13 is a side view of the foldable stroller in a completely folded state.

### DETAILED DESCRIPTION OF THE PREFERRED EMBODIMENT

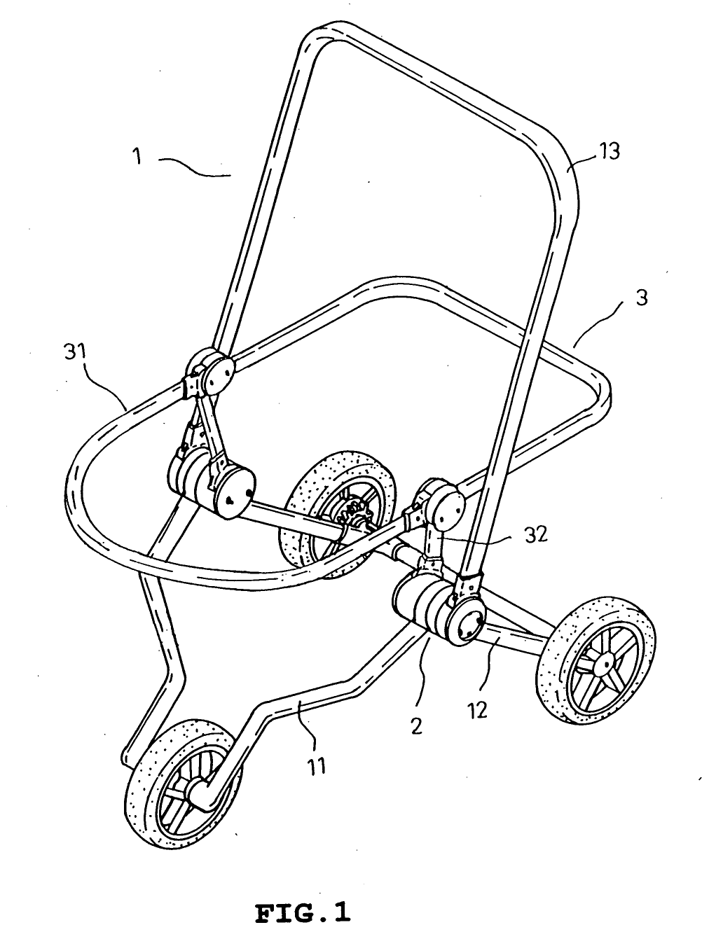

Referring to FIG. 1, a foldable stroller in accordance with the present invention comprises a main frame 1, two first pivotal mechanisms 2, and a seat fame 3 comprising two second pivotal mechanisms and two connecting beams 32. The main frame 1 comprises a front wheel frame, a rear wheel frame, and a handle 13. In this embodiment, the front wheel frame includes two arms 11 and the rear wheel frame includes two arms 12.

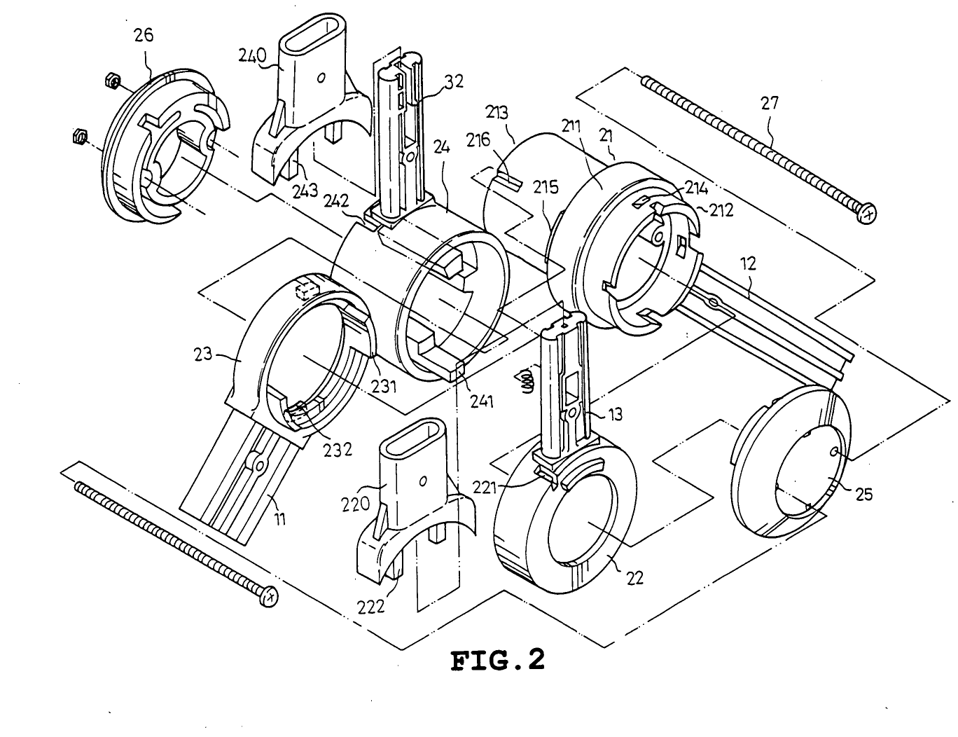

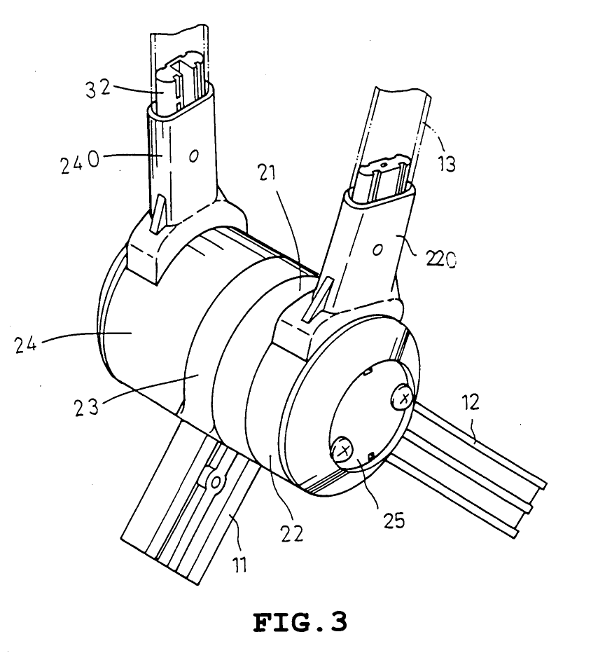

Still referring to FIG. 1 and further to FIGS. 2 and 3, each first pivotal mechanism 2 comprises a central hub 21, a first ring 22, a second ring 23, and a third ring 24. The central hub 21 includes a tubular member 211 having a first axial extension 212 on an end thereof and a second axial extension 213 on the other end thereof. A stop 215 is formed on an end face of the tubular member 211 and adjacent to the second axial extension 213. The first ring 22 is pivotally mounted to the first axial extension 212. The second ring 23 and the third ring 24 are pivotally mounted to the second axial extension 213. The first axial extension 212 includes at least one slot 214 in a periphery thereof. The second axial extension 213 includes at least one recessed portion 216 in a periphery thereof.

The first ring 22 is securely connected to an end of an associated one of two ends of the handle 13. Further, the first ring 22 is pivotally mounted around the first axial extension 212 and includes at least one slot 221 in a periphery thereof. A first positioning sleeve 220 is slidably mounted on the end of the handle 13 and includes at least one stop 222 that extends through the slot 221 of the first ring 22 and the slot 214 of the first axial extension 212. In this case, the first ring 22 and the first axial extension 212 cannot pivot relative to each other. The first positioning sleeve 220 can be moved upward, disengaging the stop 222 from the slot 214 of the first axial extension 212, allowing the first ring 22 and the first axial extension 212 to pivot relative to each other.

The second ring 23 is securely connected to an end of an associated arm 11 of the front wheel frame. Further, the second ring 23 is pivotally mounted around the second axial extension 213 and includes at least one stop 231 on a side thereof. Pivotal movement between the second end of the second ring 23 and the second axial extension 213 is stopped when the stop 231 comes in contact with and thus stopped by the stop 215 of the tubular member 211. The second ring 23 further includes at least one stop 232 on the other side thereof.

The third ring 24 is securely connected to an end of an associated connecting beam 232. Further, the third ring 24 is pivotally mounted around the second axial extension 213 and includes at least one stop 241 on a side thereof and at least one notch 242 in the other side thereof. Pivotal movement of the third ring 24 is stopped when the stop 241 of the third ring 24 comes in contact with and thus stopped by the stop 232 of the second ring 23. Further, a second positioning sleeve 240 is slidably mounted on the end of the associated connecting beam 32 and includes at least one stop 243 that extends through the notch 242 of the third ring 24 into the recessed portion 216 of the second axial extension 213. In this case, the third ring 24 and the second axial extension 213 cannot pivot relative to each other. The second positioning sleeve 240 can be moved upward, disengaging the stop 243 from the notch 242 of the third ring 24 and the recessed portion 216 of the second axial extension 213, allowing the third ring 24 and the second axial extension 213 to pivot relative to each other.

Two end caps 25 and 26 are attached to outer sides of the first and second axial extensions 212 and 213 and connected by an axle 27, providing an aesthetically pleasing appearance.

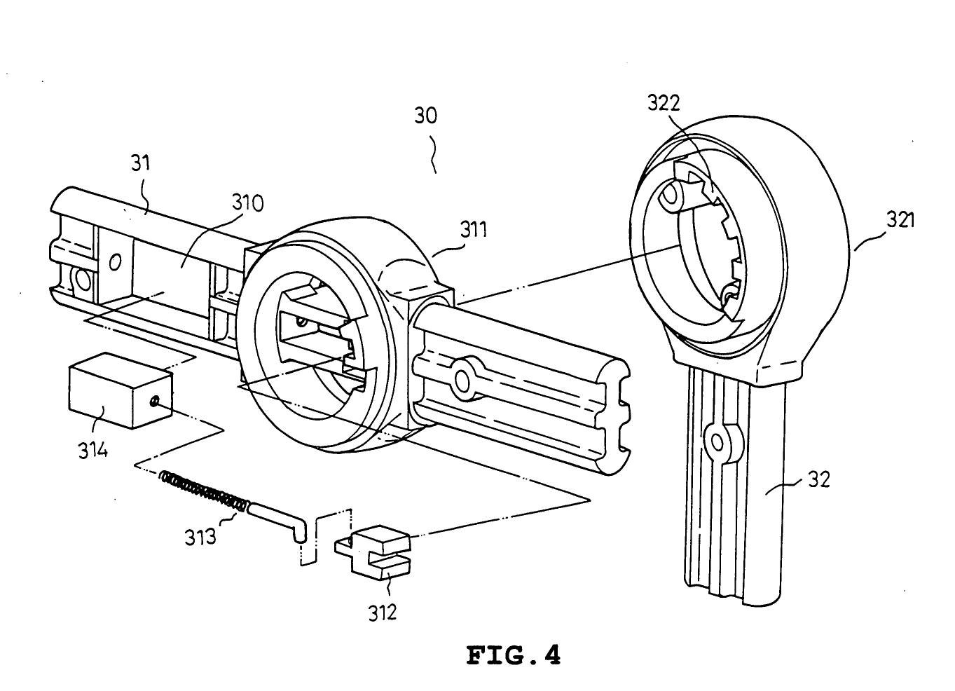

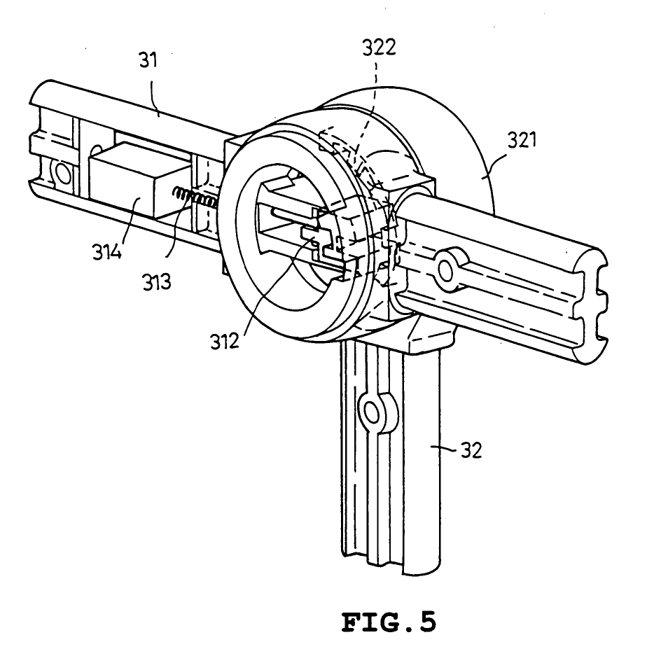

Still referring to FIG. 1 and further to FIGS. 4 and 5, the seat frame 3 includes an annular frame 31 and two connecting beams 32. As mentioned above, each connecting beam 32 includes an end securely connected to an associated third ring 24. A coupling member 321 is securely mounted to the other end of each connecting beam 32 and includes a plurality of annularly spaced engaging teeth 322. The annular frame 31 includes two coupling sections 311 on two opposite lateral portions of the annular frame 31. Each coupling section 311 defines a space in which an engaging member 312 and an elastic element 313 are mounted. Two compartments 310 are defined in the annular frame 31. Each compartment 310 is adjacent to an associated coupling section 311. An actuating member 314 is slidably mounted in each compartment 310, with an end of an associated elastic element 313 being attached to the actuating member 314 and with the other end of the associated elastic element 313 being connected to the engaging member 312. The coupling section 311 and the coupling member 321 together form the second pivotal mechanism.

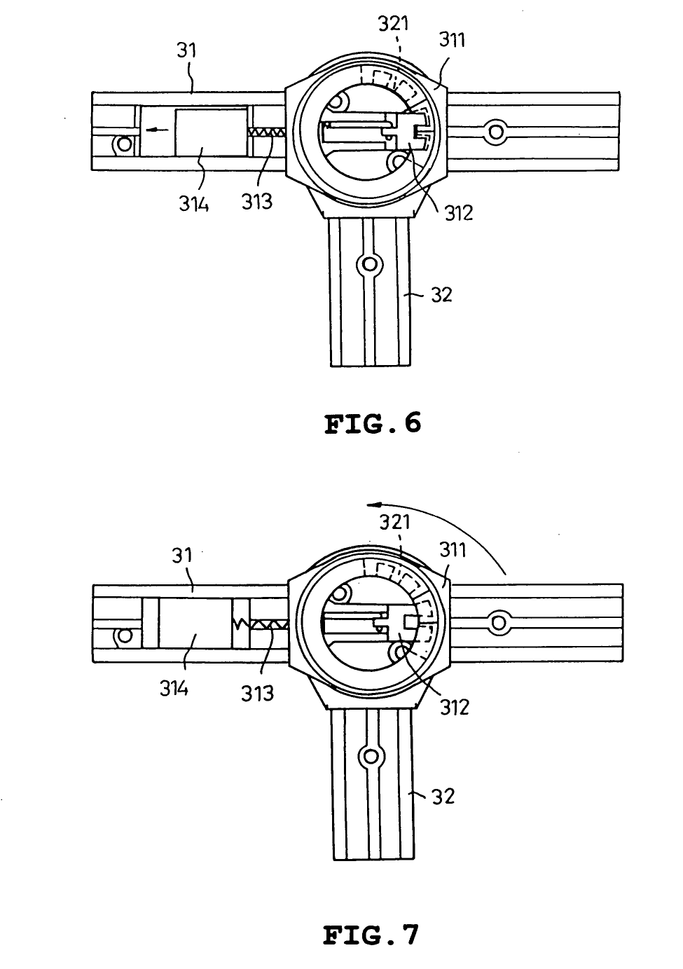

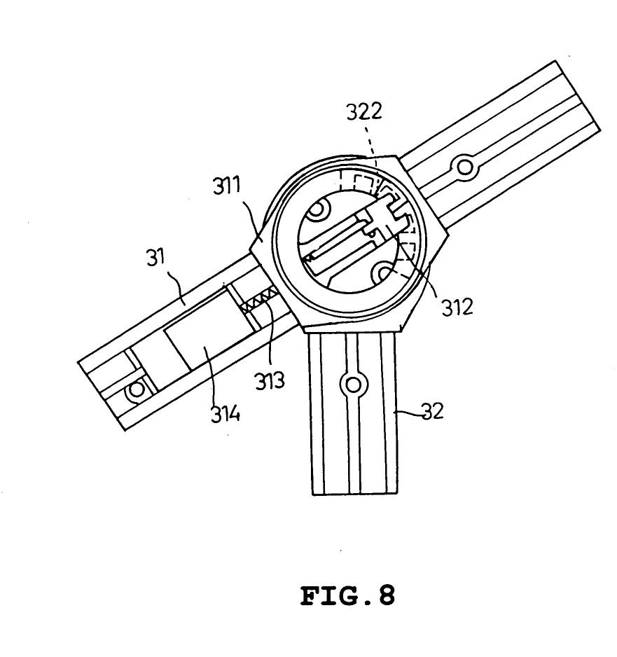

Referring to FIG. 6, when the engaging member 312 is engaged with the engaging teeth 322 of the coupling member 321, relative pivotal movement between the connecting beam 32 and the annular frame 31 is not allowed. In other words, the actuating member 314 is in a locking position. Referring to FIG. 7, when the actuating member 314 is pulled away from the coupling member 321 to an unlocking position, the engaging member 312 is disengaged from the engaging teeth 322 of the coupling member 321, allowing relative pivotal movement between the connecting beam 32 and the annular frame 31, as shown in FIG. 8. When the actuating member 314 is released, the engaging member 312 is returned to its original position shown in FIG. 6.

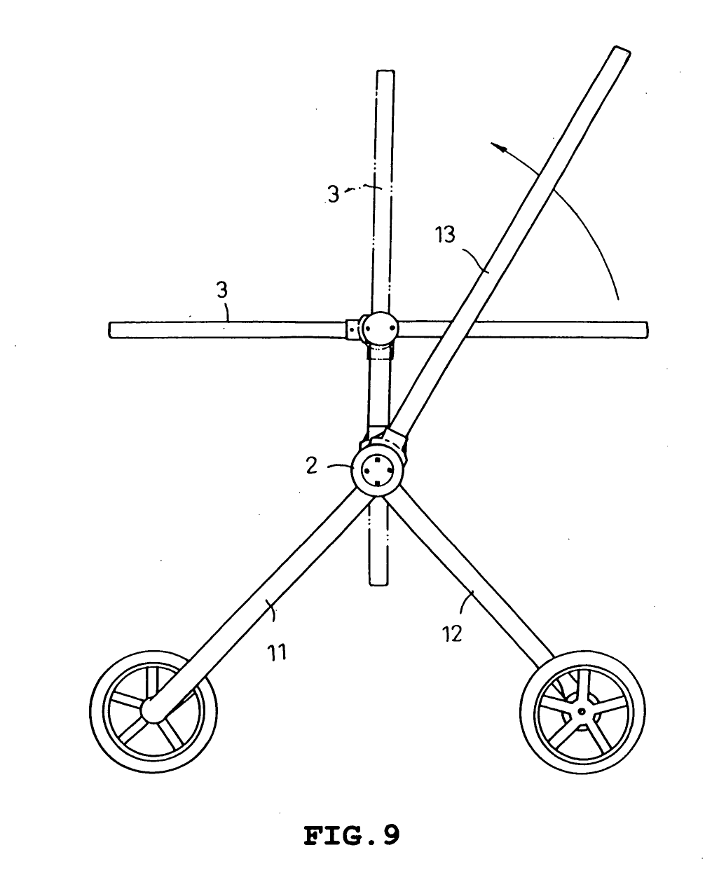

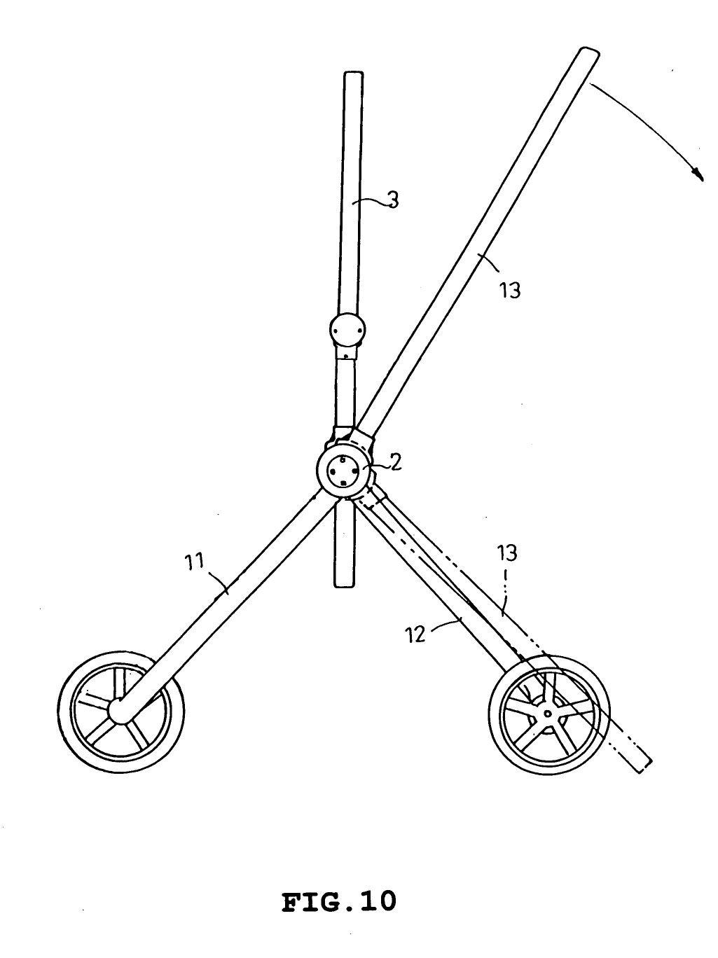

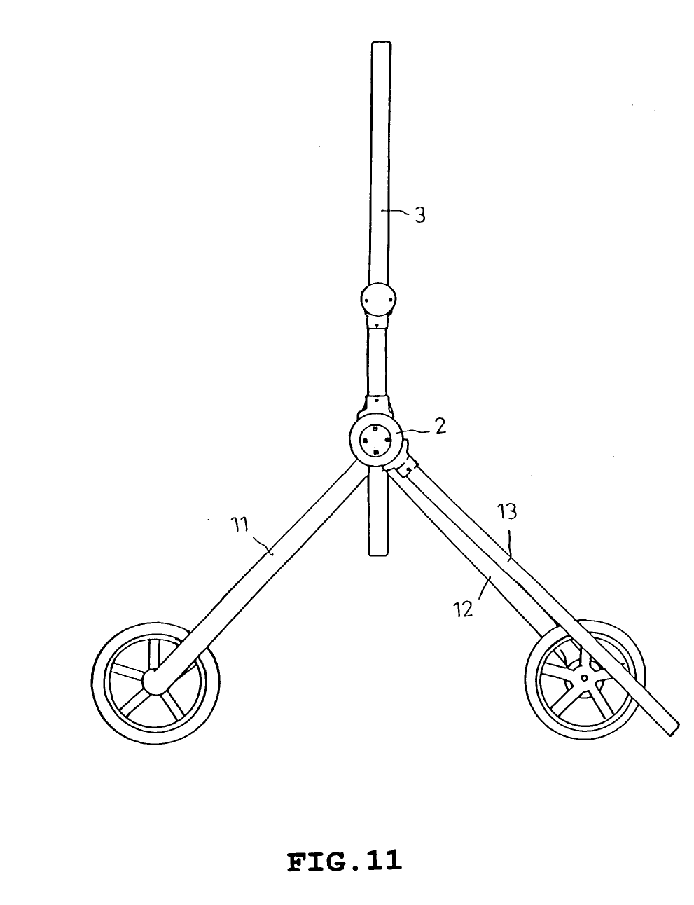

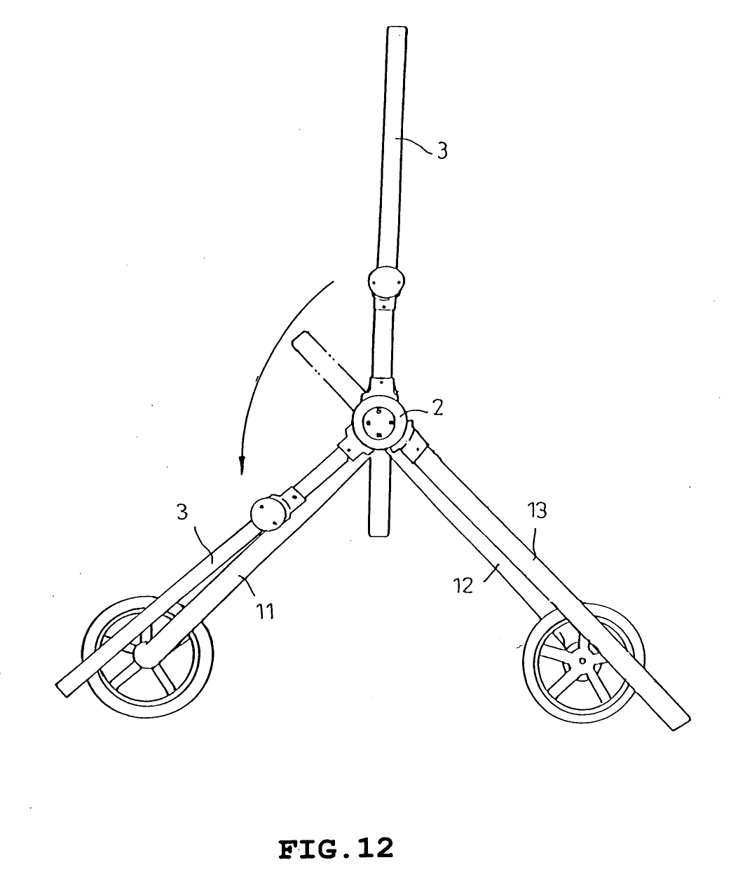

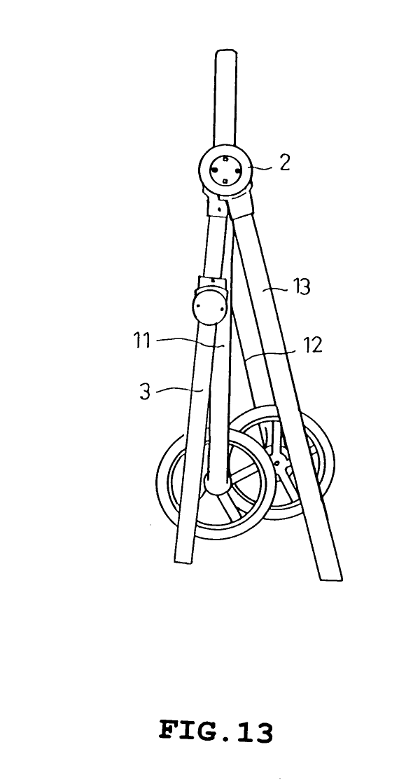

Referring to FIG. 9, when folding the stroller, the seat frame 3 is pivoted from a horizontal position to a vertical position. Next, the handle 13 is pivoted from a position shown in FIG. 10 to a position shown in FIG. 11. Then, the seat frame 3 is pivoted to a position shown in FIG. 12. Finally, the front wheel frame and the rear wheel frame are folded, as shown in FIG. 13.

Folding of the foldable stroller in accordance with the present invention can be accomplished easily and rapidly without detaching the seat frame. The folding parts of the foldable stroller are simplified, reducing the maintenance work. Further, the structural strength of the foldable stroller is improved.

Although a specific embodiment has been illustrated and described, numerous modifications and variations are still possible without departing from the essence of the invention. The scope of the invention is limited by the accompanying claims.

What is claimed is:

1. A foldable stroller comprising:
a main frame comprising a front wheel frame and a rear wheel frame, the front wheel frame including two arms, the rear wheel frame including two arms;
a seat frame comprising an annular frame and two connecting beams;
two pivotal mechanisms; and
a handle having two ends;
each said arm of the front wheel frame being pivotally connected to an associated one of the pivotal mechanisms, each said arm of the rear wheel frame being pivotally connected to an associated one of the pivotal mechanisms, each said end of the handle being pivotally connected to an associated one of the pivotal mechanisms, each said connecting beam including an end pivotally connected to an associated one of the pivotal mechanisms;
the annular frame including two coupling sections on two opposite lateral portions thereof, each said coupling section being pivotally connected to another end of an associated one of the connecting beams.

2. The foldable stroller as claimed in claim 1 wherein each said coupling section includes an engaging member mounted therein, said another end of the associated connecting beam including a plurality of annularly spaced engaging teeth, the engaging member being releasably engaged with the engaging teeth, wherein relative pivotal movement between each said coupling section and the associated connecting beam is not allowed when the engaging member is engaged with the engaging teeth, and wherein relative pivotal movement between each said coupling section and the associated connecting beam is allowed when the engaging member is disengaged from the engaging teeth.

3. The foldable stroller as claimed in claim 2, wherein the annular frame includes two compartments respectively adjacent to the coupling sections, an actuating member being movably mounted in each said compartment, an elastic element being attached between each said actuating member and an associated one of the engaging member, wherein the engaging member is disengaged from the engaging teeth when the actuating member is moved from a locking position to an unlocking position.
